(19) United States
(12) Patent Application Publication
(10) Pub. No.: US 2026/0241773 A1
(43) Pub. Date: Aug. 20, 2026

(54) THERMAL SYSTEM FOR A MOTOR VEHICLE

(71) Applicant: FLEXIS, BOULOGNE-BILLANCOURT (FR)

(72) Inventor: Gilles CASSAIGNE, GUYANCOURT (FR)

(21) Appl. No.: 19/165,396

(22) PCT Filed: Mar. 11, 2024
(86) PCT No.: PCT/EP2024/056388

§ 371 Date: Sep. 15, 2025

(30) Foreign Application Priority Data
Mar. 22, 2023 (FR) FR2302691

(51) Int. Cl. B60H 1/32; B60H 1/00; B60K 1/00

(52) U.S. Cl. CPC B60H 1/32284; B60H 1/00278; B60H 1/00885; B60H 1/323; B60K 2001/005; B60K 2001/006; B60K 2001/008

(57) ABSTRACT

A thermal system for a motor vehicle, including a first assembly including components including an electric motor, a battery, a thermal resistor, a cooler connected to an air-conditioning circuit of a passenger compartment of the motor vehicle, a radiator, further including a second assembly including ducts for a heat-transfer fluid, connecting the components of the first assembly, and a third assembly including at least one solenoid valve, and in particular at most three solenoid valves, connected to ducts of the second assembly, and, when the solenoid valve or solenoid valves of the third assembly are all in the rest state, the thermal system implements a first circulation of heat-transfer fluid via said ducts in a first series circuit interconnecting the components of the first assembly.

The invention relates to a thermal system for a motor vehicle. The invention also relates to a method for thermal management of a motor vehicle. The invention further relates to a motor vehicle equipped with a thermal system.

To minimize the energy consumption of motor vehicles, especially electric vehicles, cooling circuits are designed to recover the heat generated by one element of the circuit to warm another element of the circuit. More generally, a cooling circuit must allow different circulations of the coolant to adapt to different usage conditions of the vehicle, for example, different heating needs of the passenger compartment, while minimizing the energy consumption of the vehicle. Moreover, a cooling circuit must be designed to facilitate its maintenance, i.e., the periodic replacement of the coolant.

However, the implementation of such cooling circuits can be complex and may require the use of many controllable components, including numerous pumps and solenoid valves, which increases the cost and complexity of developing the cooling system.

The aim of the invention is to provide a thermal system that addresses the above disadvantages and improves known systems from the prior art. In particular, the invention allows for the creation of a reliable and efficient thermal system that minimizes the number of controllable components and simplifies the maintenance of the cooling circuit.

To this end, the invention relates to a thermal system for a motor vehicle comprising a first assembly including components among which
an electric motor,
a battery,
a thermal resistor,
a cooler connected to an air-conditioning circuit of a passenger compartment of the motor vehicle,
a radiator,
   the thermal system further comprising a second assembly including ducts for a heat-transfer fluid, connecting the components of the first assembly, and a third assembly including at least one solenoid valve, and in particular at most three solenoid valves, connected to ducts of the second assembly,
   and, when the solenoid valve or solenoid valves of the third assembly are all in the rest state, the thermal system implements a first circulation of heat-transfer fluid via said ducts in a first series circuit interconnecting the components of the first assembly.

In one embodiment, the thermal system is capable of implementing by actuating the solenoid valve or valves:
a second circulation of heat-transfer fluid via said ducts moving, on the one hand, between the radiator and the electric motor, and, on the other hand, between the electric resistor or the cooler and the battery, and/or
a third circulation of heat-transfer fluid via said ducts moving between the electric motor and the battery, and/or
a fourth circulation of heat-transfer fluid via said ducts moving, on the one hand, between the electric motor and the battery, and, on the other hand, between the electric resistor and the battery, and/or
a fifth circulation of heat-transfer fluid via said ducts moving in a loop near the electric motor without passing through the cooler or the battery, and/or
a sixth circulation of heat-transfer fluid via said ducts moving between the electric motor and the cooler without passing through the battery.

In one embodiment, the third assembly consists of
a single solenoid valve with at least seven ways, or
two solenoid valves, including one four-way solenoid valve and one solenoid valve with at least three ways, or
three solenoid valves with at least three ways.

In one embodiment, the thermal system comprises a single degassing tank, and/or the degassing tank is a circulating type tank, and/or the degassing tank and the radiator are arranged on parallel circuit portions by said ducts, and/or an altitude of the degassing tank is higher than an altitude of each component of the first assembly.

The invention also relates to a method for thermal management of a motor vehicle equipped with a thermal system according to the invention, comprising:
a first maintenance step of the thermal system, and/or
a second step of cooling the electric motor by the radiator further comprising cooling and/or warming the battery by the cooler and/or by the electric resistor, the second step comprising implementing the second circulation, and/or
a third step of warming the battery by recovering heat released by the electric motor further comprising warming, by the thermal resistor, a heat-transfer fluid circulating upstream of the cooler, the third step comprising implementing the third circulation, and/or
a fourth step of warming the battery by recovering heat released by the electric motor and by the thermal resistor, further comprising warming, by the thermal resistor, a heat-transfer fluid circulating upstream of the cooler, the fourth step comprising implementing the fourth circulation, and/or
a fifth step of recovering heat released by the electric motor to exclusively warm the electric motor, further comprising warming, by the thermal resistor, a heat-transfer fluid circulating upstream of the cooler, the fifth step comprising implementing the fifth circulation, and/or
a sixth step of recovering heat released by the electric motor to warm a heat-transfer fluid circulating upstream of the cooler, the sixth step comprising implementing the sixth circulation.

In one embodiment, the first maintenance step of the thermal system comprises:
a sub-step of implementing the first circulation, then
a sub-step of draining a heat-transfer fluid circulating in the set of ducts of the thermal system, then
a sub-step of filling the set of ducts of the thermal system with a new heat-transfer fluid, then
a sub-step of evacuating gas bubbles contained in the set of ducts of the thermal system.

The invention also relates to a thermal management system comprising hardware and/or software elements implementing the method according to the invention, notably hardware and/or software elements designed to implement a method according to the invention, and/or the device comprising means to implement the method according to the invention.

The invention further relates to a motor vehicle equipped with a thermal system according to the invention.

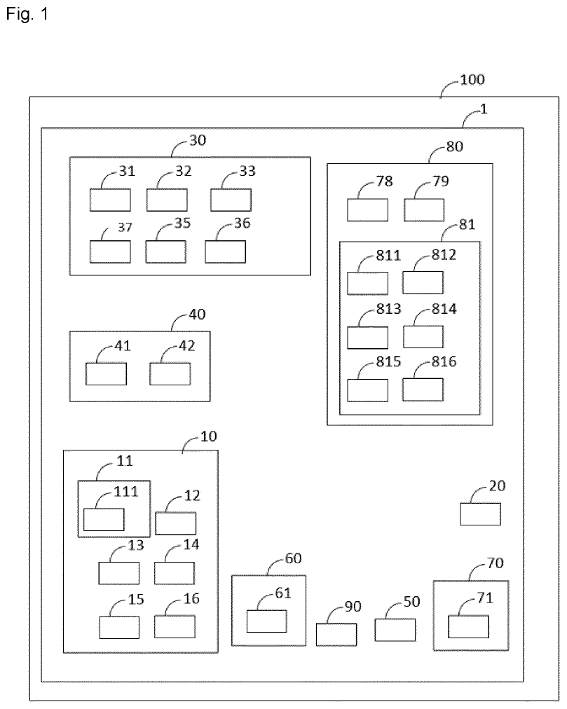

FIG. 1 schematically represents a motor vehicle equipped with a thermal system according to one embodiment of the invention.

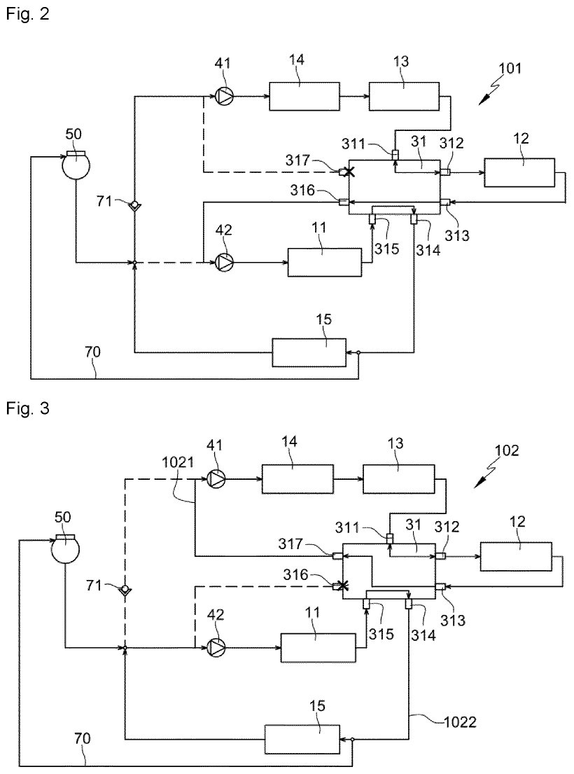

FIG. 2 represents an implementation of a first circulation of heat-transfer fluid in a thermal system according to a first embodiment of the invention.

FIG. 3 represents an implementation of a second circulation of heat-transfer fluid in a thermal system according to the first embodiment of the invention.

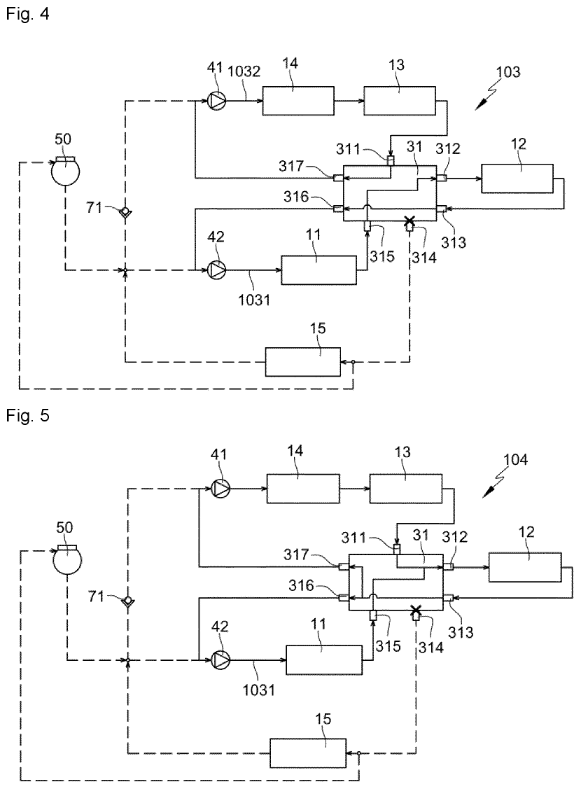

FIG. 4 represents an implementation of a third circulation of heat-transfer fluid in a thermal system according to the first embodiment of the invention.

FIG. 5 represents an implementation of a fourth circulation of heat-transfer fluid in a thermal system according to the first embodiment of the invention.

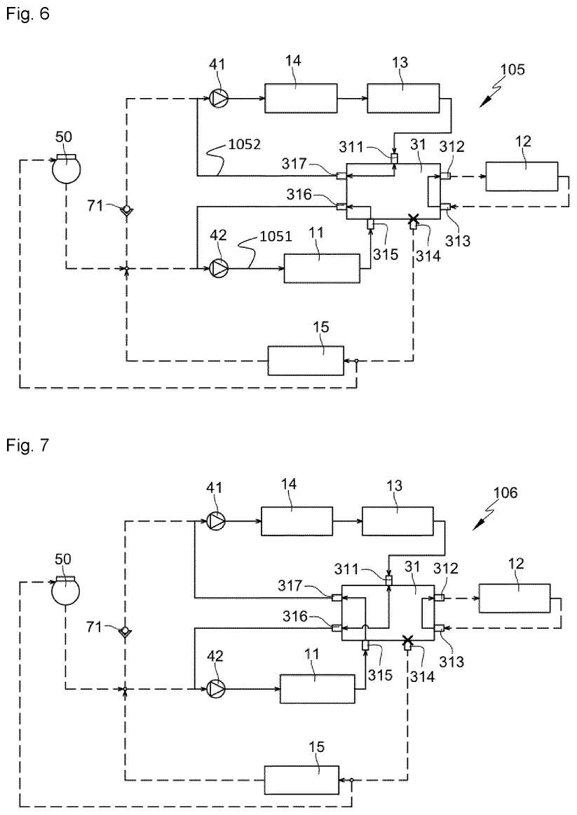

FIG. 6 represents an implementation of a fifth circulation of heat-transfer fluid in a thermal system according to the first embodiment of the invention.

FIG. 7 represents an implementation of a sixth circulation of heat-transfer fluid in a thermal system according to the first embodiment of the invention.

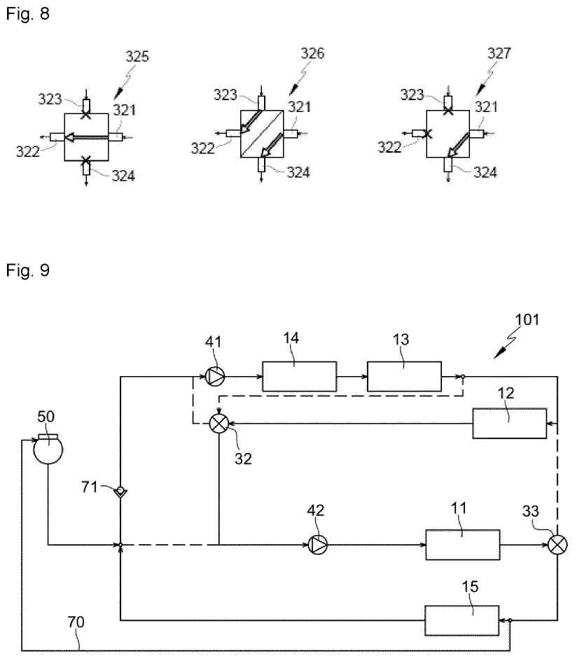

FIG. 8 represents a functional diagram of a four-way valve of a thermal system according to a second embodiment of the invention.

FIG. 9 represents an implementation of the first circulation of heat-transfer fluid in a thermal system according to the second embodiment of the invention.

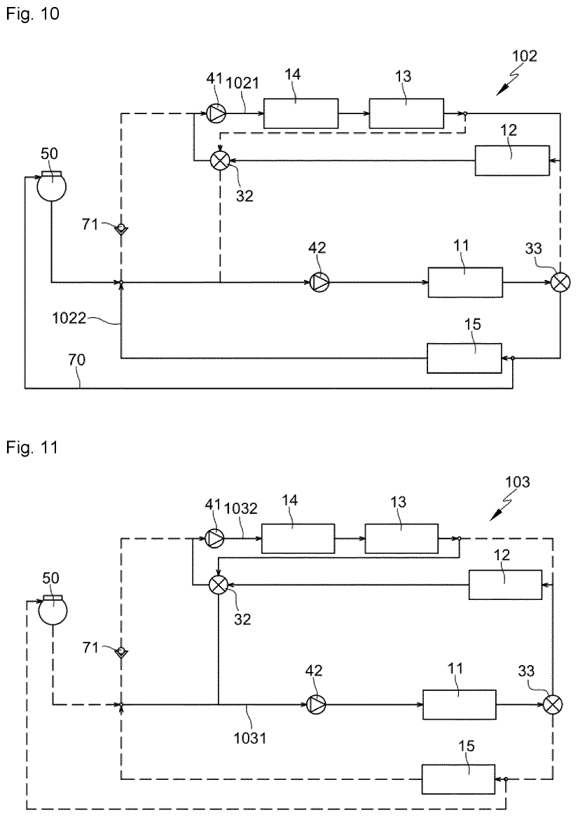

FIG. 10 represents an implementation of the second circulation of heat-transfer fluid in a thermal system according to the second embodiment of the invention.

FIG. 11 represents an implementation of the third circulation of heat-transfer fluid in a thermal system according to the second embodiment of the invention.

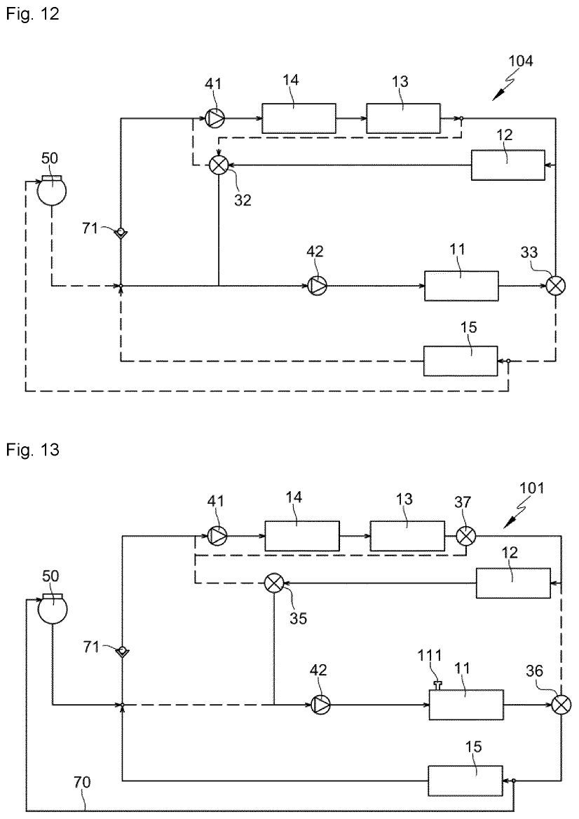

FIG. 12 represents an implementation of the fourth circulation of heat-transfer fluid in a thermal system according to the second embodiment of the invention.

FIG. 13 represents an implementation of the first circulation of heat-transfer fluid in a thermal system according to a third embodiment of the invention.

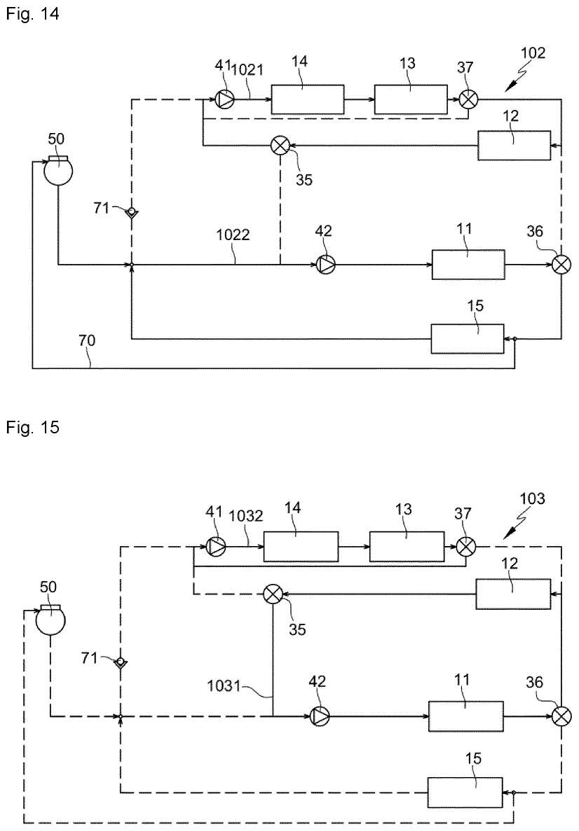

FIG. 14 represents an implementation of the second circulation of heat-transfer fluid in a thermal system according to the third embodiment of the invention.

FIG. 15 represents an implementation of the third circulation of heat-transfer fluid in a thermal system according to the third embodiment of the invention.

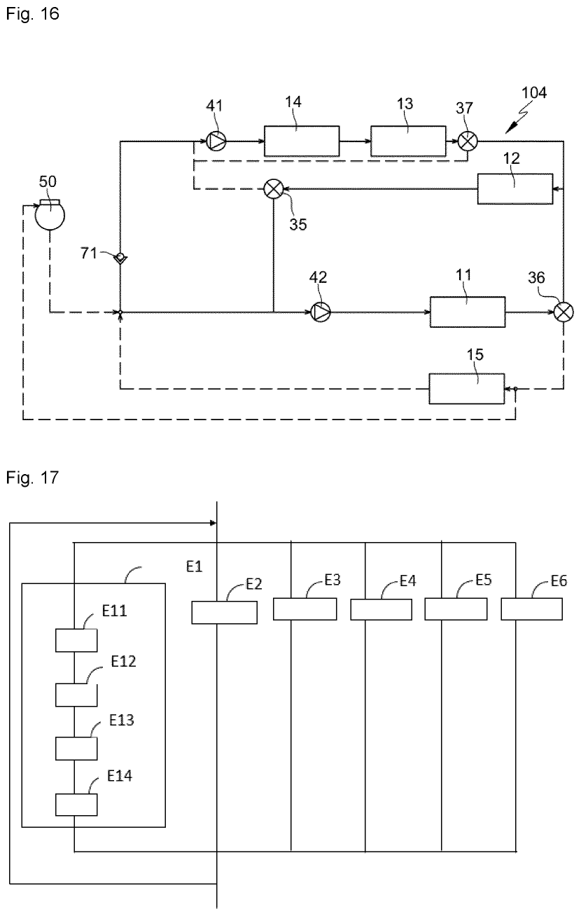

FIG. 16 represents an implementation of the fourth circulation of heat-transfer fluid in a thermal system according to the third embodiment of the invention.

FIG. 17 is a flowchart of a thermal management method according to the invention.

Three embodiments of a motor vehicle 100 according to the invention are described below with reference to FIGS. 1 to 17. The motor vehicle 100 is a motor vehicle of any type, notably a passenger vehicle or a utility vehicle.

In a more specifically described embodiment in this document, the motor vehicle 100 is an electric vehicle and comprises a first assembly 10 including components among which, an electric motor 11, a battery 12, a cooler 13 connected to an air-conditioning system of a passenger compartment of the motor vehicle 100, a thermal resistor 14, and a radiator 15.

In the rest of the document, the term “cooler 13” refers to a cooler connected to an air-conditioning system of a passenger compartment of the motor vehicle 100.

In the rest of the document, the term “motor 11” is used to refer to the electric motor itself, as well as different components associated with the motor, and located near the motor, such as current converters and a charger. In other words, the term “motor 11” encompasses a set of components dedicated to the operation of the motor 11, notably the electric traction chain comprising one or more motors and inverters and/or one or more converters and/or one or more chargers.

In the rest of the document, a thermal system 1 comprising the first assembly 10 is defined. The thermal system 1 handles the thermal management of the motor 11, the battery 12, the cooler 13 (notably by a heat exchange at the radiator 15) and the heating resistor 14.

The thermal system 1 further comprises a second assembly 20 including ducts and a third assembly 30 including at most three solenoid valves 31, 32, 33, 35, 36, 37 connected to ducts of the second assembly 20. The valves of the third assembly 30 are arranged so that, when they are all in the rest state, the thermal system 1 implements a first circulation 101 of heat-transfer fluid in a first series circuit interconnecting the components of the first assembly 10.

The radiator 15 is a cooling radiator of the vehicle. Air passing through the radiator 15 allows cooling of the heat-transfer fluid circulating in the ducts of the second assembly 20.

In the embodiments presented below, the thermal system further comprises a first pump 41 and a second pump 42 allowing the generation of a circulation of heat-transfer fluid in the ducts of the second assembly 20.

The third assembly 30 of at most three solenoid valves consists of
either a single solenoid valve 31 with at least seven ways, thus defining a first embodiment of the thermal system 1,
or two solenoid valves 32, 33, one of which is a four-way solenoid valve 32 and a solenoid valve 33 with at least three ways, thus defining a second embodiment of the thermal system 1,
or three solenoid valves 35, 36, 37 with at least three ways, thus defining a third embodiment of the thermal system 1.

A thermal system 1 according to the first, second, or third embodiment is also capable of implementing
a second circulation 102 of heat-transfer fluid moving, on the one hand, between the radiator 15 and the electric motor 11, and, on the other hand, between the electric resistor 14 or a cooler 13 and the battery 12, and/or
a third circulation 103 of heat-transfer fluid moving between the electric motor 11 and the battery 12, and/or
a fourth circulation 104 of heat-transfer fluid moving, on the one hand, between the electric motor 11 and the battery 12, and, on the other hand, between the electric resistor 14 and the battery 12, and/or
a fifth circulation 105 of heat-transfer fluid moving in a loop through the electric motor 11 without passing through the cooler 13 or the battery 12, and/or
a sixth circulation 106 of heat-transfer fluid moving between the electric motor 11 and the cooler 13 without passing through the battery 12.

With reference to FIGS. 2 to 7, a thermal system 1 according to the first embodiment is first described, allowing the implementation of the first, second, third, fourth, fifth, and sixth circulations 101, 102, 103, 104, 105, 106 alternately.

An implementation of the first circulation 101 according to the first embodiment of the thermal system 1 is illustrated by FIG. 2. The first circulation 101, which creates a series circuit of ducts connecting all the components 30, is particularly suitable for filling the thermal circuit 1 in the factory, as well as for a maintenance phase of the thermal circuit 1.

In the first embodiment, the first circulation 101 is advantageously obtained when the solenoid valve 31 (with at least 7 ways 311, 312, 313, 314, 315, 316, 317) is at rest, i.e., when the solenoid valve does not receive an activation order. In this case,
ways 311 and 312 are connected to each other, creating a circuit connecting in series the battery 12 to the assembly consisting of the heating resistor 14 in series with the cooler 13,
ways 313 and 316 are connected to each other, creating a series circuit connecting the battery 12 to the motor 11,
ways 315 and 314 are connected to each other, creating a series circuit connecting between the motor 11 and the radiator 15.

Thus, this configuration of the solenoid valve 31 allows draining and filling the ducts of the second assembly 50, without having to activate the solenoid valve 31. Then, by simply setting the regime of the water pumps placed on the circuit, the first circulation 101 can be used to expel all air bubbles trapped in the circuit. These treatments will be developed further in the document.

FIG. 3 illustrates an implementation of the second circulation 102, according to the first embodiment of the thermal system 1. An implementation of the second circulation 102 represents a main operating mode of the thermal system 1, this operating mode can be used in different phases of use of the motor vehicle 100 (driving, charging, etc.).

The second circulation 102 comprises a first circulation loop 1021 of heat-transfer fluid, allowing the management of the temperature of the battery 12. The battery 12 can be cooled or warmed by the cooler 13 and/or warmed by the heating resistor 14. If the battery does not need cooling or heating, a water flow can pass through the battery 12 to prevent the appearance of hot spots in it. To this end, the solenoid valve 31 is configured as follows,
ways 311 and 312 are connected to each other, creating a series circuit connecting the assembly consisting of the heating resistor 14 in series with the cooler 13 to the battery 12, and
ways 313 and 317 are connected to each other, creating a circuit connecting the battery 12 to a first water pump 41 located upstream of the assembly consisting of the heating resistor 14 in series with the cooler 13.

The second circulation 102 further comprises a second loop 1022 of heat-transfer fluid circulation, allowing cooling of the components of the electric traction chain, i.e., the motor 11, by the radiator 15. To this end, the solenoid valve 31 is further configured as follows: ways 314 and 315 are connected to each other, creating a circuit connecting the motor 11 to the radiator 15.

FIG. 4 illustrates an implementation of the third circulation 103, according to the first embodiment of the thermal system 1.

The third circulation 103 allows the implementation of a first energy recovery mode comprising two circulation loops 1031, 1032. In the first circulation loop 1031, the heat from the motor 11 is transmitted to the battery 12 to increase its temperature. Moreover, in the second loop 1032, the thermal resistor can be used to support the operation of the air conditioning when the outside temperature is low, and when the heat pump is used in heat pump mode for passenger compartment thermal needs.

In other words, in the case of low temperatures, notably below 0°, the third circulation allows the autonomy of the motor vehicle 100 to be increased. Indeed, thanks to a first loop 1031, heating the battery 12 by the motor 11 allows the energy that can be extracted from the battery to be increased without using the heating resistor 14. Moreover, thanks to a second loop 1032, the heat provided by the thermal resistor 14 allows the air conditioning (operating in heat pump mode) to be quickly brought to a temperature favoring its energy efficiency, notably by transferring calories through the cooler 13 then functioning as a heater of the refrigerant fluid circulating in the air conditioning circuit.

To this end, the solenoid valve 31 is configured as follows,
the first loop 1031 containing the battery 12 and the motor 11 is created by connecting ways 312 and 315 on the one hand, and ways 313 and 316 on the other hand, and
ways 311 and 317 are connected to each other, to create the second loop 1032, i.e., a circuit connecting the heating resistor 14 in series with the cooler 13.

FIG. 5 illustrates an implementation of the fourth circulation 104, according to the first embodiment of the thermal system 1.

The fourth circulation 104 allows the implementation of a second energy recovery mode. In this energy recovery mode, the battery 12 receives the heat generated by the motor 11 and can also receive part of the heat released by the thermal resistor 14. The heat released by the thermal resistor 14 is also used to support the operation of the air conditioning (operating in heat pump mode).

The fourth circulation 104 is particularly interesting when the outside temperature is low, notably below 10° C.

Heating the battery 12 by the motor 11 allows the energy that can be extracted from the battery to be increased without using the heating resistor 14. Moreover, the heat provided by the thermal resistor 14 allows the air conditioning (operating in heat pump mode) to be quickly brought to a temperature favoring its energy efficiency.

To this end, the solenoid valve 31 is configured as follows,
ways 311 and 312 are connected to each other, thus directing a heat-transfer fluid heated by the heating resistor 14 to the battery 12,
ways 315 and 312 are connected to each other, thus directing a heat-transfer fluid heated by the motor 11 to the battery 12, and
way 313 is connected to ways 316 and 317 for the return of the heat-transfer fluid to the motor 11 and the heating resistor 14.

FIG. 6 illustrates an implementation of the fifth circulation 105, according to the first embodiment of the thermal system 1. The fifth circulation 105 is particularly interesting when the outside temperature is extremely low, for example, when the outside temperature is below 0°, for example, around −20° C.

In a first circulation loop of the heat-transfer fluid, the fifth circulation 105 allows the calories generated by the operation of the motor 11 to be used exclusively for heating the motor 11. The calories produced by the operation of the motor 11 are not evacuated to any other component, notably the calories produced by the motor are not directed to the air conditioning circuit via the exchanger 13. The first loop allows a rise in temperature of the motor oil in extremely cold conditions, which improves the operation of the motor.

Moreover, the fifth circulation 105 allows the implementation of a second closed loop of heat-transfer fluid circulation, including the thermal resistor 14 in series with the cooler 13, the calories produced by the activation of the thermal resistor 14 constituting a heat source intended for the air conditioning circuit.

Thus, the fifth circulation 105 creates two isolated heat-transfer fluid circulation loops, on the one hand in the electric motor 11 and on the other hand in the exchanger 13, without passing through the battery 12 which is in a nominal operating state.

To this end, the solenoid valve 31 is configured as follows:
to create the first closed loop of heat-transfer fluid circulation in the motor 11, ways 315 and 316 are connected to each other,
to create the second closed loop of heat-transfer fluid circulation in the thermal resistor 14 in series with the exchanger 13, ways 311 and 317 are connected to each other, and
to prevent circulation of the heat-transfer fluid in the battery, ways 312 and 313 are connected to each other.

FIG. 7 illustrates an implementation of the sixth circulation 106, according to the first embodiment of the thermal system 1. The sixth circulation 106 is particularly interesting when the cold outside temperature is between 0° C. and 10° C.

The sixth circulation 106 creates a circulation loop of the heat-transfer fluid connecting in series the electric motor 11, the resistor 14 in series with the exchanger 13, which functions as a heater of the air conditioning circuit. Advantageously, the thermal resistor 14 can be deactivated, so that the passenger compartment of the motor vehicle is heated only by the calories produced by the motor 11. Moreover, the battery is in self-thermal management mode due to its operation at nominal temperature. As a result, the battery 12 is isolated from the circulation loop connecting the electric motor 11, the resistor 14, and the exchanger 13. In other words, there is no thermal exchange between the battery 12 and the cooling fluid circulating through the motor 11 and the exchanger 13.

To this end, the solenoid valve 31 is configured as follows:
to create the closed loop of heat-transfer fluid circulation in the motor 11, the resistor 14, and the exchanger 13, way 311 is connected to way 316, and way 315 is connected to way 317, and
to prevent circulation of the heat-transfer fluid in the battery, ways 312 and 313 are connected to each other.

With reference to FIGS. 8 to 12, a thermal system 1 according to the second embodiment is then described, allowing the implementation of the first, second, third, and fourth circulations 101, 102, 103, 104 alternately.

In the second embodiment of the thermal system 1, the set of solenoid valves 3 consists of two solenoid valves 32, 33, at least one of which is a four-way solenoid valve 32 and a solenoid valve with at least three ways 33.

FIG. 8 represents a functional diagram of the four-way solenoid valve 32 of a thermal system according to the second embodiment of the invention, wherein:
a first way 321 is connected by a duct to the battery 12,
a second way 322 is connected to the first pump 41,
a third way 323 is connected to the cooler 13, and
a fourth way 324 is connected to the second pump 42.

Moreover, FIG. 8 describes three configurations 325, 326, 327 implemented by the four-way solenoid valve 32, each configuration being obtained by connecting at least two ways taken from the four ways 321, 322, 323, 324 of the solenoid valve 32:
the first configuration 325 connects the battery 12 to the first pump 41,
the second configuration 326 connects the cooler 13 to the first pump 41 and the battery to the second pump 42,
the third configuration 327 connects the battery 12 to the second pump 42.

A solenoid valve with at least three ways 33 and the three configurations 325, 326, 327 described for the solenoid valve 32 allow the implementation of the first, second, third, and fourth circulations 101, 102, 103, 104.

An implementation of the first circulation 101 by a thermal system according to the second embodiment (i.e., with solenoid valves 32 and 33) is illustrated by FIG. 9.

In the second embodiment, the first circulation 101 is advantageously obtained when
the solenoid valve 32 is in the third configuration 327, i.e., the solenoid valve 32 connects the battery 12 to the second pump 42, and
the solenoid valve 33 connects the motor 11 to the radiator.

Thus, all the components of the set of components 10 are connected in series.

An implementation of the second circulation 102 by a thermal system 1 according to the second embodiment is illustrated by FIG. 10. The second circulation 102 is advantageously obtained when
the solenoid valve 32 is in the first configuration 325, i.e., the solenoid valve 32 connects the battery 12 to the first pump 41, and
the solenoid valve 33 connects the motor 11 to the radiator.

An implementation of the third circulation 103 by a thermal system 1 according to the second embodiment is illustrated by FIG. 11. The third circulation 103 is advantageously obtained when
the solenoid valve 32 is in the second configuration 326, i.e., the solenoid valve 32 connects the cooler 13 to the first pump 41 and the battery to the second pump 42, and
the solenoid valve 33 connects the motor 11 to the battery 12.

An implementation of the fourth circulation 104 by a thermal system 1 according to the second embodiment is illustrated by FIG. 12. The fourth circulation 104 is advantageously obtained when
the solenoid valve 32 is in the third configuration 327, i.e., the solenoid valve 32 connects the battery 12 to the second pump 42, and
the solenoid valve 33 connects the motor 11 to the battery 12.

With reference to FIGS. 13 to 16, a thermal system 1 according to the third embodiment is then described, allowing the implementation of the first, second, third, and fourth circulations 101, 102, 103, 104 alternately.

In the third embodiment of the thermal system 1, the set of solenoid valves 3 consists of three solenoid valves 35, 36, 37 with at least three ways.

An implementation of the first circulation 101 by a thermal system 1 according to the third embodiment is illustrated by FIG. 13. In the third embodiment, the first circulation 101 is advantageously obtained when
the solenoid valve 35 connects the battery 12 to the second pump 42, and
the solenoid valve 36 connects the motor 11 to the radiator.

An implementation of the second circulation 102 by a thermal system 1 according to the third embodiment is illustrated by FIG. 14. In the third embodiment, the second circulation 102 is advantageously obtained when
the solenoid valve 35 connects the battery 12 to the first pump 41, and
the solenoid valve 36 connects the motor 11 to the radiator,
the solenoid valve 37 connects the battery in series with the heating resistor and the air conditioning.

An implementation of the third circulation 103 by a thermal system 1 according to the third embodiment is illustrated by FIG. 15. The third circulation 103 is advantageously obtained when
the solenoid valve 35 connects the battery to the second pump 42,
the solenoid valve 37 connects the cooler 13, and
the solenoid valve 36 connects the motor 11 to the battery 12.

An implementation of the fourth circulation 104 by a thermal system 1 according to the third embodiment is illustrated by FIG. 16. The fourth circulation 104 is advantageously obtained when
the solenoid valve 35 connects the battery 12 to the second pump 42, and
the solenoid valve 36 connects the motor 11 to the battery 12.

In the rest of the document, the term “tank” or “degassing tank” is used to name an expansion vessel, also called “manifold.” A tank of a thermal system is pressurized and serves to create sufficient pressure at the inlet of each water pump of the thermal system to prevent cavitation in the water pump. Indeed, if the pressure at a pump is too low, a cavitation phenomenon can occur, i.e., boiling of the heat-transfer fluid at the pump blades, which damages the pump blades.

Advantageously, the degassing tank 50 can be a circulating type tank, i.e., the tank 50 includes a first inlet fitting for the heat-transfer fluid placed in its upper part, and a second outlet fitting for the fluid placed at its lowest point.

In a preferred embodiment, the thermal system 1 comprises a single degassing tank 50, which facilitates maintenance operations of the thermal system 1.

Moreover, the position of the tank 50 on the circuit of the thermal system can be chosen to favor rapid and simple degassing of the circuit, notably by creating a circuit connecting in series all the components of the first assembly. Advantageously, the tank 50 can be placed on a circuit loop 70 in parallel with the component offering the highest resistance to the passage of the heat-transfer fluid, such as the radiator 15. Air bubbles are then pushed towards the tank 50, the tank 50 allowing separation of liquid and gaseous phases.

Furthermore, an altitude of the degassing tank 50 is preferably higher than an altitude of each component of the first assembly 10 of components.

The thermal system may further comprise a check valve 71 or non-return valve 71 to prevent the heat-transfer fluid from moving in the opposite direction to a desired direction of movement. Such a phenomenon can occur notably due to negative pressures in a duct upstream of a pump.

The thermal system 1 may comprise a controller 90 that determines which circulation of heat-transfer fluid should be implemented, among the first, second, third, fourth, fifth, or sixth circulations. The controller 90 can, for example, manage the conditions of transition from one circulation to another, for example, based on an outside air temperature of the vehicle and/or a passenger compartment temperature setpoint and/or a vehicle usage mode, the vehicle usage mode can be a driving mode or a maintenance mode.

In an advantageous embodiment, the thermal system 1 further comprises means for implementing a thermal management method according to the invention. Notably, the thermal system 1 comprises a processing unit 80 comprising a microprocessor 81, a memory 78, and communication interfaces 79.

The thermal system 1 and particularly the microprocessor 81, mainly comprises the following modules that cooperate with each other:
a module 811 for maintenance of the thermal system, this module can cooperate with the controller 90, the solenoid valves of the third assembly 30, the first and second pumps 41, 42,
a module 812 for cooling the electric motor by the radiator, this module being able to cooperate with the controller 90, the solenoid valves of the third assembly 30, the first and second pumps 41, 42,
a module 813 for warming the battery by recovering heat released by the electric motor, this module being able to cooperate with the controller 90, the solenoid valves of the third assembly 30, the first and second pumps 41, 42,
a module 814 for warming the battery by recovering heat released by the electric motor and by the thermal resistor, this module being able to cooperate with the controller 90, the solenoid valves of the third assembly 30, the first and second pumps 41, 42,
a module 815 for recovering heat released by the operation of the electric motor to exclusively warm the electric motor, this module being able to cooperate with the controller 90, the solenoid valves of the third assembly 30, the first and second pumps 41, 42,
a module 816 for recovering heat released by the electric motor to warm a heat-transfer fluid circulating upstream of the cooler, this module being able to cooperate with the controller 90, the solenoid valves of the third assembly 30, the first and second pumps 41, 42.

The motor vehicle 100, particularly the thermal system 1, preferably comprises all the hardware and/or software elements configured to implement the method defined in the object of the invention or the method described below.

With reference to FIG. 17, a thermal management method is described comprising an alternation between:
a first step E1 of maintaining the thermal system, comprising implementing the first circulation 101,
a second step E2 of cooling the electric motor by the radiator, comprising implementing the second circulation 102,
a third step E3 of warming the battery by recovering heat released by the electric motor, comprising implementing the third circulation 103,
a fourth step E4 of warming the battery by recovering heat released by the electric motor and by the thermal resistor, comprising implementing the fourth circulation 104,
a fifth step E5 of recovering heat released by the operation of the electric motor to exclusively warm the electric motor, comprising implementing the fifth circulation 105,
a sixth step E6 of recovering heat released by the electric motor to warm a heat-transfer fluid circulating upstream of the cooler, comprising implementing the sixth circulation 106.

The first step E1 of maintaining the thermal system 1 comprises:
a sub-step E11 of implementing the first circulation 101, then
a sub-step E12 of draining a heat-transfer fluid circulating in the set of ducts 20 of the thermal system 1, then
a sub-step E13 of filling the set of ducts 20 of the thermal system 1 with a new heat-transfer fluid, then
a sub-step E14 of evacuating gas bubbles contained in the set of ducts 20 of the thermal system 1.

The first step E1 comprises receiving a maintenance order for the thermal system 1, the order being issued by the controller 90.

Following the receipt of a maintenance order, in sub-step E11 the solenoid valves of the thermal system 1 are configured to allow the implementation of the first circulation 101 of heat-transfer fluid. For this, the solenoid valves of the third assembly 30 are commanded to implement a circuit connecting in series the components of the first assembly 10. Advantageously, the thermal system 1 is designed so that circulation 101 is implemented when the solenoid valves are in the rest state.

Then a sub-step E12 of draining the heat-transfer fluid contained in the thermal system 1 is carried out. After opening the drain plugs, the heat-transfer fluid naturally flows out of the set of ducts 20, and out of the components it passes through, such as the battery 12. The heat-transfer fluid is thus automatically replaced by air.

Once the thermal system 1 is drained, a filling tool 60 for the ducts can be used. To this end, the tool 60 is connected to the tank 50.

The tool 60 is equipped with a vacuum pump that sucks the air present in the ducts of the assembly 20. The tool 60 thus creates a vacuum in the ducts of the assembly 20, notably the pressure inside the ducts is close to 900 millibars.

Then a sub-step E13 of filling the ducts with a new heat-transfer fluid is carried out. For this, the ducts of the assembly 20 are connected to a heat-transfer fluid reservoir that is part of the tool 60, the fluid reservoir being at atmospheric pressure. The heat-transfer fluid will be sucked into the ducts of the assembly 20, due to the vacuum previously created in the ducts. Thus, a pressure balancing phenomenon allows the ducts of the assembly 20 to be filled with a new heat-transfer fluid. However, the filling—although facilitated by the tool 60—is not perfect, as a large amount of air may remain in the ducts and/or components of the thermal system 1.

In a sub-step E14 of degassing, a circulation of heat-transfer fluid is activated in all the ducts of the assembly 20. In other words, the first circulation 101 is implemented, notably by starting the pumps 41, 42 of the thermal system 1. Advantageously, the implementation of the first circulation 101 allows residual air pockets to be moved to the degassing tank. Upstream of sub-step E14, i.e., imperatively before starting the pumps 41, 42, manual purge screws 111 positioned on local high points, such as on the motor 11, can be opened.

In other words,
sub-step E12 of draining comprises suction of the heat-transfer fluid generating a pressure lower than atmospheric pressure in the ducts of the second assembly 20, and/or
sub-step E13 of filling comprises pressure injection of a new heat-transfer fluid into the second assembly 20 of ducts, and/or
the thermal system 1 comprises at least one pump 41, 42 and sub-step E14 of evacuating gas bubbles contained in the thermal system 1 comprises circulation of the new fluid by actuating at least one pump 41, 42.

In addition or alternatively, sub-step E13 of filling comprises a pressure injection of the new heat-transfer fluid into the second assembly 20 of ducts.

In addition or alternatively, the thermal system 1 comprises at least one pump 41, 42 and the sub-step of evacuating gas bubbles contained in the thermal system comprises circulation of the new fluid by actuating at least one pump.

Moreover, in one embodiment, the radiator comprises a purge screw, and the sub-step of degassing comprises evacuation of gas bubbles by opening the purge screw.

The second step E2 comprises receiving an order to implement the second circulation 102, the order being issued by the controller 90. Following the receipt of this order, the second circulation 102 is implemented. For this, the solenoid valves are actuated to create
a first circulation loop 1021 of heat-transfer fluid, allowing the management of the temperature of the battery 12, the battery 12 being able to be cooled or warmed by the air conditioning via the cooler 13 and/or warmed by the heating resistor 14, and/or
a second loop 1022 of heat-transfer fluid circulation, allowing cooling of the components of the electric traction chain, i.e., the motor 11, by the radiator 15.

The third step E3 comprises receiving an order to implement the third circulation 103, the order being issued by the controller 90. Following the receipt of this order, the third circulation 103 is implemented. For this, the solenoid valves are actuated to create
a first circulation loop 1031, wherein the heat from the motor 11 is transmitted to the battery 12 to increase its temperature, and/or
a second circulation loop 1032, wherein the thermal resistor can be used to support the operation of the air conditioning when the outside temperature is low, and when the heat pump is used in heat pump mode for passenger compartment thermal needs.

The fourth step E4 comprises receiving an order to implement the fourth circulation 104, the order being issued by the controller 90. Following the receipt of this order, the fourth circulation 104 is implemented. For this, the solenoid valves are actuated so that the battery 12 receives the heat generated by the motor 11 and/or the battery can also receive part of the heat released by the thermal resistor 14.

The fifth step E5 comprises receiving an order to implement the fifth circulation 105, the order being issued by the controller 90. Following the receipt of this order, the fifth circulation 105 is implemented. For this, the solenoid valves are actuated to create
a first circulation loop 1051, wherein the heat emitted by the operation of the motor 11 is exclusively used to increase the temperature of the motor 11, and/or
a second circulation loop 1052, wherein the thermal resistor can be used to support the operation of the passenger compartment air conditioning when the outside temperature is low, and when the heat pump is used in heat pump mode for passenger compartment thermal needs.

The sixth step E6 comprises receiving an order to implement the fifth circulation 106, the order being issued by the controller 90. Following the receipt of this order, the sixth circulation 106 is implemented. For this, the solenoid valves are actuated to create a circulation wherein the heat emitted by the operation of the motor 11 is exclusively used to support the operation of the passenger compartment air conditioning when the outside temperature is low, and when the heat pump is used in heat pump mode for passenger compartment thermal needs.

Finally, the thermal system according to the invention and the thermal management method according to the invention present several advantages.

Firstly, they improve the energy autonomy of the motor vehicle equipped with the invention. Indeed, thanks to the different circulations of heat-transfer fluid implemented by the thermal system, several modes of energy recovery from the electric traction chain to the battery are possible. Similarly, it is also possible to use calories from the cooling circuit to heat the passenger compartment of the motor vehicle via the cooler connected to the air conditioning circuit. This limits the activation of the heating resistor to heat the battery or the passenger compartment of the motor vehicle. It is also possible to cool the electric motor and the battery by the radiator located at the front of the vehicle, which limits the activation of the electric air conditioning compressor that consumes a lot of energy.

Secondly, the thermal system according to the invention and the thermal management method according to the invention allow time savings on cooling circuit filling tasks in the factory. Indeed, the thermal system according to the invention comprises only one tank, which reduces the filling time in the factory compared to thermal systems comprising two or more tanks. The filling tasks can also be executed with a single filling machine, whereas for cooling circuits comprising several tanks, it was sometimes necessary to invest in several machines to save time on the filling phase.

Thirdly, the thermal system according to the invention and the thermal management method according to the invention allow time savings in after-sales maintenance. Indeed, thanks to the optimal position of the tank of the cooling circuit in the system, the tank directly feeding the two water pumps, the time required for a technician to fill the cooling circuit is reduced. Moreover, a mode of circulation of the cooling fluid, corresponding to the first circulation previously described, has been designed to facilitate the degassing of the cooling circuit after a filling carried out during a maintenance visit of the motor vehicle. This mode allows all the components of the cooling circuit to be degassed at the same time via the tank mounted in parallel with the radiator. The time required to degas the cooling circuit is greatly reduced, which contributes to the reduction of the TCO (acronym for “Total Cost of Ownership”) of the vehicle, i.e., to the reduction of the total cost of ownership of the vehicle. Fourthly, the first embodiment of the thermal system (and, to a lesser extent, the second embodiment) allows a significant reduction in the number of solenoid valves required to implement the thermal system. This results in a reduction in the number of actuators and thus a reduction in the cost of the parts constituting the cooling circuit. Moreover, this simplifies the calibration phase of the thermal system, reducing the costs associated with the calibration phase.

1. A thermal system for a motor vehicle, comprising a first assembly comprising components comprising:
an electric motor;
a battery;
a thermal resistor;
a cooler connected to an air-conditioning circuit of a passenger compartment of the motor vehicle; and
a radiator,
wherein the thermal system further comprises a second assembly comprising ducts for a heat-transfer fluid, connecting the components of the first assembly, and a third assembly comprising at least one solenoid valve, and at most three solenoid valves, connected to ducts of the second assembly, and
wherein, when the solenoid valve or solenoid valves of the third assembly are all in a rest state, the thermal system implements a first circulation of heat-transfer fluid via said ducts in a first series circuit interconnecting the components of the first assembly.

2. The thermal system according to claim 1, configured to implement by actuating the solenoid valve or valves:
a second circulation of heat-transfer fluid via said ducts moving between the radiator and the electric motor, and between the thermal resistor or the cooler and the battery; and/or
a third circulation of heat-transfer fluid via said ducts moving between the electric motor and the battery; and/or
a fourth circulation of heat-transfer fluid via said ducts moving between the electric motor and the battery, and between the thermal resistor and the battery; and/or
a fifth circulation of heat-transfer fluid via said ducts moving in a loop near the electric motor without passing through the cooler or the battery; and/or
a sixth circulation of heat-transfer fluid via said ducts moving between the electric motor and the cooler without passing through the battery.

3. The thermal system according to claim 1, wherein the third assembly consists of:
a single solenoid valve with at least seven ways, or
two solenoid valves, among which one solenoid valve with four ways, and one solenoid valve with at least three ways, or
three solenoid valves with at least three ways.

4. The thermal system according to claim 1, comprising a single degassing tank, and/or wherein the degassing tank is a circulating type tank and/or wherein the degassing tank and the radiator are arranged on parallel circuit portions by said ducts, and/or wherein an altitude of the degassing tank is higher than an altitude of each component of the first assembly.

5. A thermal management method for a motor vehicle equipped with a thermal system according to claim 2, comprising:
a first step of maintaining the thermal system; and/or
a second step of cooling the electric motor by the radiator further comprising cooling and/or warming the battery by the cooler, and/or by the thermal resistor, the second step comprising implementing the second circulation; and/or
a third step of warming the battery by recovering heat released by the electric motor further comprising warming, by the thermal resistor, a heat-transfer fluid circulating upstream of the cooler, the third step comprising implementing the third circulation; and/or
a fourth step of warming the battery by recovering heat released by the electric motor and by the thermal resistor, further comprising warming, by the thermal resistor, a heat-transfer fluid circulating upstream of the cooler, the fourth step comprising implementing the fourth circulation; and/or
a fifth step of recovering heat released by the electric motor to exclusively warm the electric motor, further comprising warming, by the thermal resistor, a heat-transfer fluid circulating upstream of the cooler, the fifth step comprising implementing the fifth circulation; and/or
a sixth step of recovering heat released by the electric motor to warm a heat-transfer fluid circulating upstream of the cooler, the sixth step comprising implementing the sixth circulation.

6. The thermal management method according to claim 5, wherein the first step of maintaining the thermal system comprises:
a sub-step of implementing the first circulation;
a sub-step of draining a heat-transfer fluid circulating in the set of ducts of the thermal system;
a sub-step of filling the-set of ducts of the thermal system with a new heat-transfer fluid; and
a sub-step of evacuating gas bubbles contained in the set of ducts of the thermal system.

7. The thermal system according to claim 1, the system comprising hardware and/or software elements implementing the thermal management method for the motor vehicle equipped with the thermal system, the method comprising:
a first step of maintaining the thermal system; and/or
a second step of cooling the electric motor by the radiator further comprising cooling and/or warming the battery by the cooler and/or by the thermal resistor, the second step comprising implementing the second circulation; and/or
a third step of warming the battery by recovering heat released by the electric motor further comprising warming, by the thermal resistor, a heat transfer fluid circulating upstream of the cooler, the third step comprising implementing the third circulation; and/or
a fourth step of warming the battery by recovering heat released by the electric motor and by the thermal resistor, further comprising warming, by the thermal resistor, a heat-transfer fluid circulating upstream of the cooler, the fourth step comprising implementing the fourth circulation; and/or
a fifth step of recovering heat released by the electric motor to exclusively warm the electric motor, further comprising warming, by the thermal resistor, a heat transfer fluid circulating upstream of the cooler, the fifth step comprising implementing the fifth circulation; and/or
a sixth step of recovering heat released by the electric motor to warm a heat transfer fluid circulating upstream of the cooler, the sixth step comprising implementing the sixth circulation.

8. The motor vehicle equipped with a thermal system according to claim 1.
